(19) United States
(12) Patent Application Publication
(10) Pub. No.: US 2010/0079569 A1
(43) Pub. Date: Apr. 1, 2010

(54) FLUID EJECTING DEVICE AND IMAGE FORMING METHOD

(75) Inventors: Toshio Kumagai, Shiojiri-shi (JP); Kazutoshi Fujisawa, Okaya-shi (JP); Shinichi Kamoshida, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/568,771

(22) Filed: Sep. 29, 2009

(30) Foreign Application Priority Data
Sep. 30, 2008 (JP) 2008-254361

(51) Int. Cl. B41J 2/01

(52) U.S. Cl. 347/102

(57) ABSTRACT

A fluid ejecting device includes a transporting member for transporting a medium in a transporting direction, a fluid ejecting head for ejecting fluid containing a color material onto the medium, an irradiating unit provided on the downstream side of the fluid ejecting head in the transporting direction to cure the fluid by irradiating the fluid on the medium with ultraviolet rays, and a charge applying member for applying charges to the color material of the fluid on the medium before irradiation of the fluid with the ultraviolet rays.

This application claims the benefit of Japanese Patent Application No. 2008-254361, filed Sep. 30, 2008, which is expressly incorporated herein by reference in its entirety.

### BACKGROUND

1. Technical Field

The present invention relates to a fluid ejecting device and an image forming method.

2. Related Art

As a fluid ejecting device, there is an ink jet printer which prints an image by ejecting fluid (ink) onto various kinds of media such as paper, cloth, film. The printer includes a transporting member which transports a medium in a transporting direction and a fluid ejecting head which ejects ink onto the medium.

There is also a printer including an irradiating unit which cures ink by irradiating ultraviolet rays (UV rays) on the ink onto the medium. That is, since the ultra violet rays from the irradiating unit are incident onto the ink which is ejected from the fluid ejecting head and then lands on the medium, the ink is cured and the image is printed (see JP-A-2007-320236).

The ink ejected from the fluid ejecting head contains various substances such as a solvent and a UV-curable resin along with a color material. Accordingly, when the ink is irradiated with UV rays, the UV-curable resin is mainly cured. On the other hand, the color material (pigment) blocks or reflects the UV rays. For such a reason, in the case in which the color material is distributed on the surface of the ink, it becomes difficult for the UV rays to reach the inside of the ink, so that only the UV-curable resin positioned at the surface of the ink is cured. As a result, there is a possibility that the ink will not be adequately cured.

### SUMMARY

An advantage of some aspects of the invention is that it provides a technique of appropriately curing fluid.

According to one aspect of the invention, there is provided a fluid ejecting device including a transporting member which transports a medium in a transporting direction, a fluid ejecting head which ejects fluid containing a color material to the medium, an irradiating unit which is provided on the downstream side of the fluid ejecting head in the transporting direction and cures the fluid by irradiating ultra violet (UV) rays to the fluid on the medium, and a charge applying member which applies charges to the color material of the fluid on the medium before the irradiation of the UV rays.

Other features of the invention will be described in the specification with reference to the accompanying drawings.

### BRIEF DESCRIPTION OF THE DRAWINGS

The invention will be described with reference to the accompanying drawings, wherein like numbers reference like elements.

FIG. 1 is a block diagram schematically illustrating the entire structure of a printer 1 according to a first embodiment of the invention.

FIG. 2 is a schematic view illustrating the inside structure of the printer 1.

FIG. 3 is a view for explaining arrangement of nozzles of a head unit 30.

FIG. 4 is a schematic view illustrating a voltage applying unit 60 and so on.

FIG. 5A is a schematic view illustrating a state where the ink is inadequately cured due to pigments blocking ultraviolet (UV) rays. FIG. 5B is a schematic view illustrating a state where the ink is adequately cured due to the pigments moving to paper S side.

FIG. 6 is a flow chart for explaining printing processing according to the embodiment of the invention.

FIG. 7 is a view illustrating the action of an electric field on ink containing a charged pigment.

FIG. 8 is a schematic view illustrating a paper transporting unit 20 and a voltage applying unit 60 according to a second embodiment of the invention.

### DESCRIPTION OF EXEMPLARY EMBODIMENTS

At least the followings is apparent from the descriptions in the specification and drawings.

A fluid ejecting device includes a transporting member which transports a medium in a transporting direction, a fluid ejecting head which ejects fluid containing a color material onto the medium, an irradiating unit which is provided on the downstream side of the fluid ejecting head in the transporting direction and which cures the fluid by irradiating the ultraviolet rays on the fluid onto the medium, a charge applying member which applies charges to the color material of the fluid on the medium before the irradiation of the UV rays. In the fluid ejecting device, the color material in the fluid, to which the charges are applied, moves to the printing surface side of the medium due to an electric field. Thus, materials in the fluid other than the color material (for example, UV-curable resin) are susceptible to irradiation by the UV rays. Therefore, the fluid can be adequately cured.

Preferably, the fluid ejecting device may further include an electric field generating member which generates an electric field which is used to influence the fluid containing the color material to which the charges are applied by working together with the charge applying member which faces the electric field generating member via the medium provided between them, in which the charge applying member is positioned on the irradiating member side when viewed from the medium side, the electric field generating member is positioned on the opposite side to the irradiating unit when viewed from the medium side, and the color material to which the charges are applied move in a direction from the charge applying member side to the electric field generating member side due to the action of the electric field. In such a case, since the color material to which the charges are applied easily moves to the printing surface side of the medium due to the electric field, the UV rays can be easily irradiated on the UV-curable resin. As a result, the fluid can be effectively cured.

In the fluid ejecting device, it is preferable that the charge applying member be provided on the downstream side of the fluid ejecting head in the transporting direction while it is spaced from the fluid ejecting head. In such a case, it is possible to prevent problems with liquid ejection that occur when the fluid containing a pigment to which the charges are applied by the charge applying member sticks to, for example, the fluid ejecting head.

An image forming method includes transporting a medium, ejecting fluid containing a color material to the medium which is being transported, applying charges to the color material of the fluid on the medium, and curing the fluid by irradiating UV rays onto the fluid containing the color material to which the charges are applied. According to the image forming method, the color material to which the charges are applied moves to the printing surface side of the medium due to the action of the electric field. Accordingly, materials other than the color material in the fluid (for example, UV-curable resin) can be easily irradiated with UV rays. Therefore, it becomes possible to adequately cure the fluid.

### First Embodiment

### Structure of an Ink Jet Printer

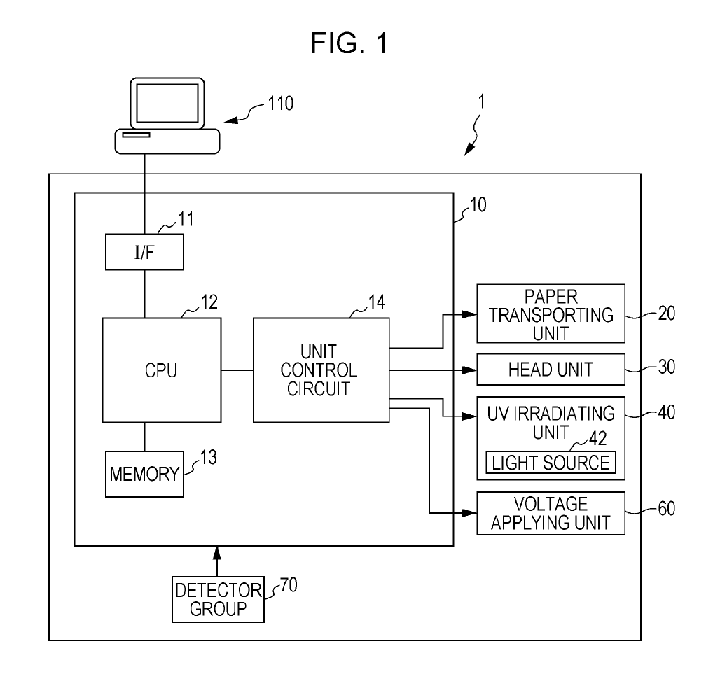

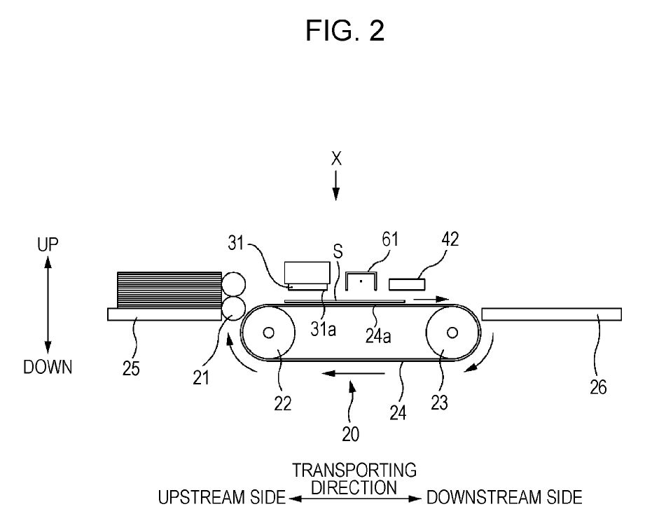

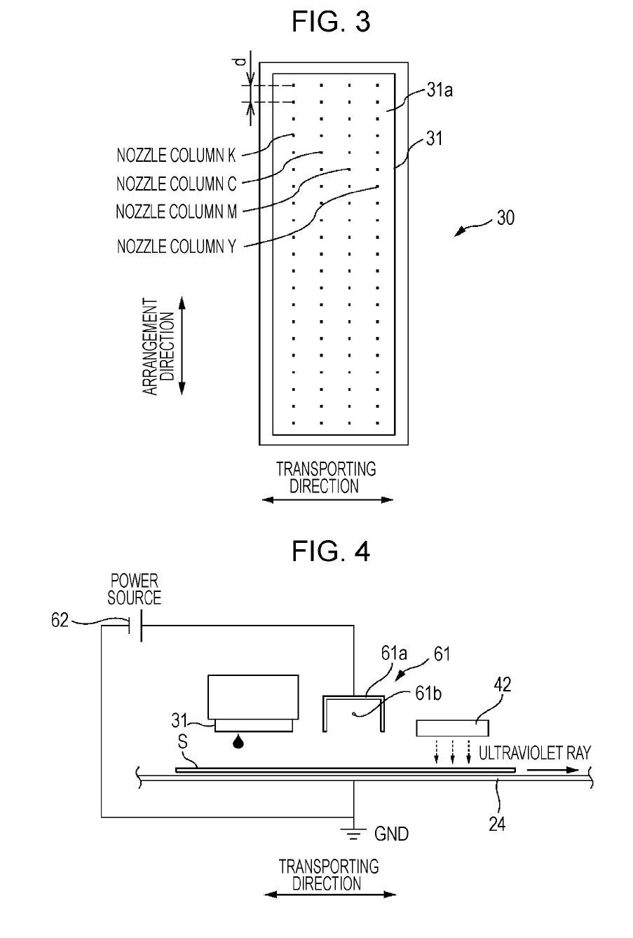

The structure of an ink jet printer (hereinafter, just referred to as printer 1) which is an example of a fluid ejecting device will be described with reference to FIGS. 1 to 4. FIG. 1 is a block diagram schematically illustrating the entire structure of the printer 1. FIG. 2 is a schematic view illustrating the inside structure of the printer 1. FIG. 3 is a view for explaining the arrangement of nozzles of a head unit 30. FIG. 4 is a schematic view illustrating a voltage applying unit 60 and so on.

The printer 1 receives printing data from a computer 110, which is an external device, controls every unit (a paper transporting unit 20, a head unit 30, a UV irradiating unit 40, and a voltage applying unit 60) by a controller 10 and forms an image on paper S which is a medium. The conditions in the printer 1 are monitored by a detector group 70 and the controller 10 controls every unit of the printer on the basis of the detection results from the detector group.

The controller 10 is a control unit for controlling the printer 1. An interface 11 performs data exchange the between the computer 110, which is an external deice, and the printer 1. A central processing unit (CPU) 12 is an operation processing device for controlling the entire printer 1. A memory 13 has a program storage area for storing programs of the CPU 12 and an operation area. The CPU 12 controls all of the units of the printer by a unit control circuit 14 according to the programs stored in the memory 13.

The paper transporting unit 20 is a medium transporting mechanism for sending paper S to a printable position and transporting the paper S in a transporting direction by a predetermined transporting amount when printing. As shown in FIG. 2, the paper transporting unit 20 has a paper sending roller 21, transporting rollers 22 and 23, and a transporting belt 24. The transporting rollers 22 and 23 and the transporting belt 24 correspond to a transporting member of the embodiment.

The paper sending roller 21 is a roller which uses its rotary motion to send paper S stacked on a paper supply tray 25 onto the transporting belt 24. The transporting rollers 22 and 23 use their rotary motion to drive the transporting belt 24 having a ring shape to circulate in a direction of arrow as shown in FIG. 2. The transporting belt 24 uses its circulating motion to transport the paper S in the transporting direction while supporting the paper S by the support surface 24a. The paper S transported by the transporting rollers 22 and 23 and the transporting belt 24 is discharged onto a paper discharge tray 26.

The head unit 30 forms dots on the paper S by ejecting ink, which is the fluid, onto the paper S which is being transported. The head unit 30 has a fluid ejecting head (hereinafter, just referred to as head 31) which ejects ink onto the paper S supported by the transporting belt 24 which faces the head unit. The head 31 is provided with a plurality of nozzles arranged so as to eject ink. In greater detail, the head 31 is provided with four nozzle columns, as shown in FIG. 3. The four nozzles columns are a black ink nozzle column (nozzle column K), a cyan ink nozzle column (nozzle column C), a magenta ink nozzle column (nozzle column M), and a yellow ink nozzle column (nozzle column Y).

Each of the nozzle columns includes a plurality of nozzles arranged in a line at predetermined intervals d from one another in an arrangement direction (FIG. 3). Each of the nozzles includes a pressure chamber (not shown) which contains ink therein and a driving element (piezo-electric element) for ejecting the ink by changing the volume of the pressure chamber. The length of each of the nozzle columns in the arrangement direction is longer than that of the paper S in the arrangement direction (i.e. paper width). Accordingly, dots are formed all over the area of the paper S in the widthwise direction by a single ejection of the head 31.

The ink used in the above embodiment may be a ultraviolet ray curable ink (UV-curable ink) which can be cured by UV rays. Here the UV-curable ink is prepared by adding additives such as antifoam and polymerization inhibitor to a mixture of vehicle, a photopolymerization initiator, and a pigment (a kind of color material). The vehicle is prepared by adjusting the viscosity of an oligomer or a monomer (corresponding to the UV-curable resin) having photopolymerization curability with a reactive diluent. The ink includes both aqueous ink and oily ink.

The UV irradiating unit 40 is used to cure the ink on the paper S. The UV irradiating unit 40 has a light source 42 which is an example of an irradiating unit which irradiates UV rays onto the ink on the paper S. As the light source 42, for example, a metal halide lamp is used. Further, the light source 42 is provided on the downstream side of the head 31 in the transporting direction of the head 31. The width of the light source 42 (length of the paper S in the widthwise direction) is almost equal to the length of the nozzle column in the arrangement direction. As the UV rays are irradiated from the light source 42 and the ink is cured, the image becomes printed on the paper S.

As shown in FIG. 4, the voltage applying unit 60 includes a power source 62 and a charging member 61 which is an example of a charge applying member. The power source 62 is a direct current source and is connected to the charging member 61 and the transporting belt 24. The charging member 61 faces the transporting belt 24 via the paper S provided between them. That is, the charging member 61 is placed on the light source 42 side when viewing from the paper S and the transporting belt 24 is placed on the opposite side of the light source 42 when viewing from of the paper S. The charging member 61 applies charges to pigments (or charges the pigments) in the ink before the irradiation of the UV rays.

Here, a charging member 61 having a corona charging system will be described as an example of the charging member. The charging member 61 includes an electrode plate 61a formed of a stainless steel metal and a wire electrode 61b made of tungsten-based wire.

The electrode plate 61a faces the transporting belt 24. The electrode plate 61a takes a ⊃ shape and is open at a side thereof where the electrode plate 61a faces the transporting belt 24. The distance between the electrode plate 61a and the transporting belt 24 is about 20 mm. The wire electrode 61b is positioned at the center of the electrode plate 61a. Thus, the wire electrode 61b is applied with a direct current voltage of 3 kV to 5 kV but the electrode plate 61a is grounded.

As a result, discharge of electricity occurs between the wire electrode 61b and the electrode plate 61a, resulting in the generation of positive ions, and there is a steady current flow of about 300 to 500 μA. In this state, the generated positive ions stick to the pigments in the ink on the paper S. The pigments to which the positive ions stick to are charged positively because the positive ions deprive the pigments of electrons. That is, charges are applied to the pigments.

The width of the charging member 61 (the length of the paper S in the widthwise direction) is almost equal to the width of the light source 42. The charging member 61 is provided between the head 31 and the light source 42 in the transporting direction.

The transporting belt 24 connected to the power source 62 has electroconductivity. In more detail, the transporting belt 24 is manufactured by mixing polyester resin with conductive carbon black. The charging member 61 connected to the power source 62 and the transporting belt 24 which is grounded so that the electric field is generated and applied to the ink containing the charged pigments. That is, the transporting belt 24 functions as an electric field generating member.

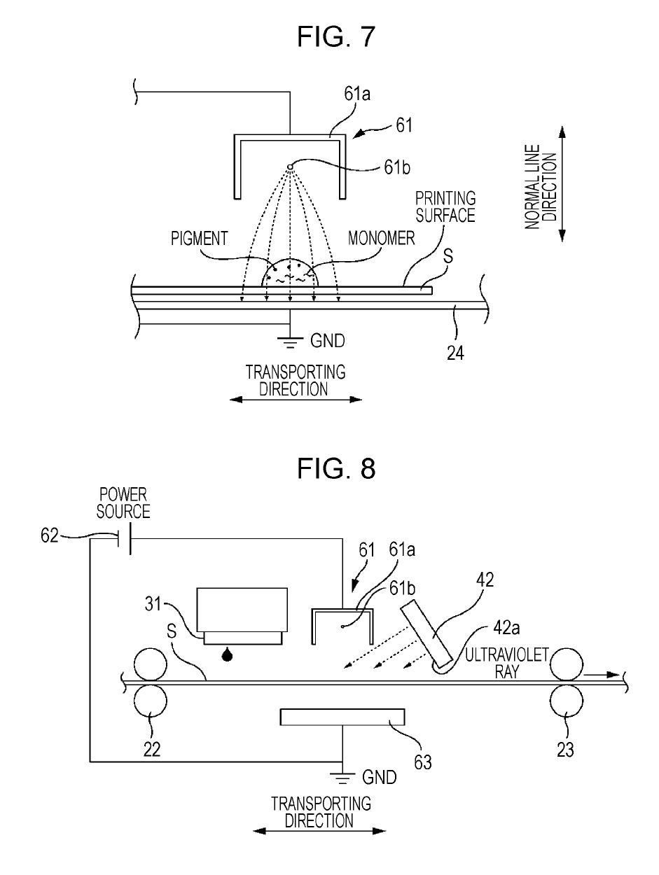

The generated electric field acts with respect to the charged pigments in a normal line direction of the paper S. In more detail, since the potential of the charging member 61 side is higher than that of the transporting belt 24, the electrical line of force of the electric field heads from the charging member 61 side to the transporting belt 24 side (see FIG. 7). Thus, the positively charged pigments move in the same direction as the electrical line of force, i.e. from the charging member 61 side to the transporting belt 24 side due to the action of the electric field.

The charging member 61 is provided on the downstream side of the head 31 in the transporting direction and spaced apart from the head 31 in order to suppress the negative influence of the generated electric field on the head 31 (for example, the sticking of the ink containing the charged pigments moving to the head due to the action of the electric field).

In the above, the charging member 61 with a corona discharging system is described. However, a charging member with a scorotron discharging system may be used. The charging member with the scorotron discharging system has a mesh-shaped electrode (grid electrode) along with the electrode plate 61a and the wire electrode 61b. Since it is possible to adjust an application voltage by the grid electrode, the charging amount for the pigments can be adjusted.

### Negative Influence of UV-Blocking Pigments on Curing of Ink

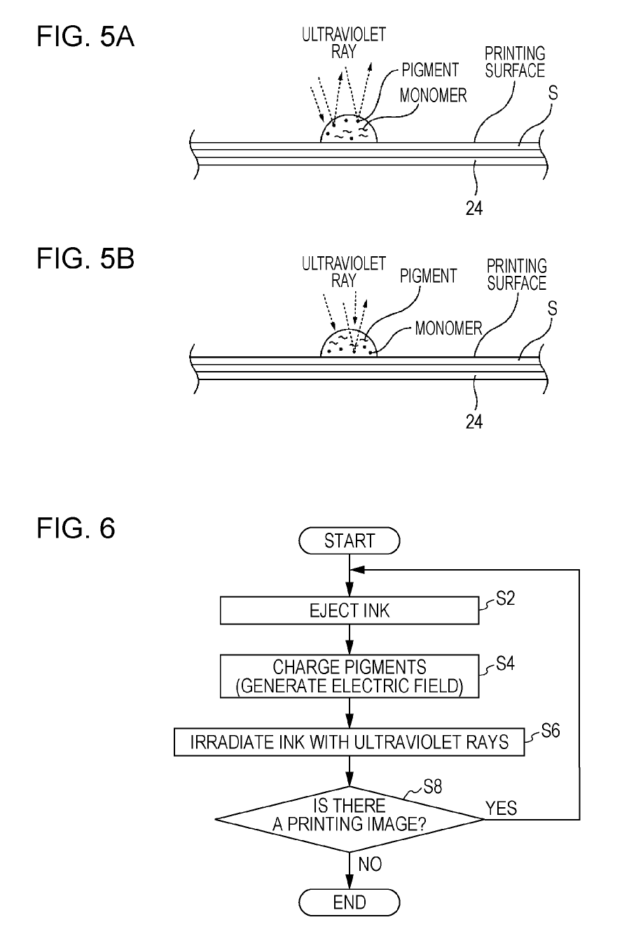

FIG. 5A is a schematic view illustrating a state where the ink is inadequately cured due to the pigments blocking the UV rays.

When using the above described printer 1, the UV rays are irradiated on the ink droplets placed onto the paper S and then the ink is cured. As described above, the ink is mainly composed of a solvent, UV-curable resin, and pigments. The UV-curable resin is cured when it is exposed to the UV rays but the pigments block or reflect the UV rays. For such a reason, in the case in which the pigments are distributed on the surface of the ink, as shown in FIG. 5A, the pigments act as obstacles when the UV rays invade into the ink, and the UV-curable resin disposed inside the ink cannot be adequately cured.

FIG. 5B is a schematic view illustrating a state where the ink is adequately cured due to the pigments being distributed on the printing surface side of the paper S instead of the surface side of ink.

In FIG. 5B, the UV-curable resin in the ink is efficiently exposed to the UV rays by performing the following printing processing because the pigments in the ink are distributed on the printing surface side of the paper S. Further, since the UV rays reflected from the pigments are irradiated onto the UV-curable resin, the UV-curable resin can be easily cured. As described above, since irradiation of the UV rays on the UV-curable resin is efficiently performed, the entire ink becomes adequately cured.

### Printing Processing

The printer 1 performs the following printing processing shown in FIG. 5B using an image forming method through which an image with less deteriorated quality can be formed.

FIG. 6 is a flowchart for explaining printing processing according to one embodiment of the invention. FIG. 7 is a view illustrating action of electric field with respect to the ink containing the charged pigments.

Operations of the printer 1 when performing the printing processing are executed mainly by the controller 10. In this embodiment, the operations are executed in a manner such that the CPU 12 processes the programs stored in the memory 13. The program is composed of codes for performing the following operations.

When forming an image while transporting the paper S, the features of the printing processing include (1) ejecting ink containing pigments to the paper S being transported, (2) applying charges to the pigments of the ink on the paper S, and (3) curing the ink by irradiating the UV rays onto the ink containing the pigments applied with charges.

First, the controller 10 has the head 31 eject ink to the paper S being transported (step S2). That is, the head 31 ejects the ink containing pigments and UV-curable resin (monomer and so on) toward the paper S which is being transported by the transporting belt 24.

Next, the controller 10 has the charging member 61 apply charges to the pigments of the ink on the paper S (step S4). That is, the discharge of electricity is generated by the charging member 61, to which a high voltage is applied from the power source 62, and then the generated positive ions stick to the pigments. As a result, the pigments in the ink on the paper S are positively charged.

While the voltage is applied to the charging member 61, electric field is generated between the charging member 61 and the transporting belt 24 which face each other via the paper S provided between them. In more detail, as shown in FIG. 7, the electric field is generated, in which the electrical line of force heads from the charging member 61 to the transporting belt 24.

The positively charged pigments in the ink are under the action of the force which heads from the charging member 61 side to the transporting belt 24 side due to the generated electric field. With such an operation, the charged pigments in the ink move to the printing surface side of the paper S. That is, the pigments to which the charges are applied move in a direction heading from the charging member 61 side to the transporting belt 24 side due to the action of the electric field. Due to this, as shown in FIG. 7, the pigments in the ink are distributed in the normal line direction on the printing surface of the paper S and the UV-curable resin (monomer and so on) is distributed on the charging member 61 side.

Since the charging member 61 is spaced apart from the head 31 and provided on the further downstream side than the head 31 in the transporting direction (see FIG. 4), even if the above-described electric field is generated, it is possible to suppress the ink containing the charged pigments from heading toward the head 31 to stick to the head 31, resulting clogging of the nozzles.

Returning to the flowchart of FIG. 6, the description continues. The controller 10 cures the ink by irradiating the UV rays onto the ink containing the charged pigments (step S6). That is, the light source 42 irradiates the UV rays with respect to the charged ink under the action of the electric field.

Since the above pigments are distributed on the printing surface side of the paper S (see FIG. 7), the UV rays can easily penetrate through the ink and can be easily irradiated onto the UV-curable resin. Accordingly, the UV-curable resin in a broad area in the ink can be sufficiently cured and the entire ink can be easily cured. Further, since the UV rays reflected from the pigments can be once more irradiated on the UV-curable resin, the efficiency of irradiation is further improved. As a result, it is possible to reduce the irradiation energy of the light source 42. In addition, since the charging member 61 and the light source 42 are placed next to each other in the transporting direction, the UV rays are irradiated on the ink with the pigments just after the electric field has been applied to the pigments.

The description will continue still with reference to the flowchart of FIG. 6. In the case of printing more images on the paper S (step S8: Yes), the above operations (steps S2 to S6) are repeated. The steps S2 to S6 are performed while the paper S is being transported. On the other hand, in the case in which there are no more images to be printed (step S8: No), the printing processing ends. As a result, the printed image has appropriate quality.

### Effectiveness of Printer 1

As described above, the printer 1 according to the present embodiment has the charging member 61 which applies charges to the pigments of the ink on the paper S before the irradiation of the UV rays.

Accordingly, the charged pigments in the ink (the positively charged pigments) move to the printing surface side of the paper S due to the action of the above-described electric field (or by applying the negative voltage to the transporting belt 24 in the case in which the electric field is not generated). Then, since the pigments and the UV-curable resin are distributed as shown in FIG. 7, blocking of the UV rays by the pigments is suppressed and the UV rays can easily permeate into the ink. As a result, since the UV-curable resin can be easily irradiated with UV rays and the entire ink on the paper S can be adequately cured.

In the above embodiment, the pigments in the ink on the paper S are positively charged, but the invention is not limited thereto. For example, the pigments may be negatively charged. In such a case, it is preferable that a voltage is applied in a manner such that the charging member 61 generates negative ions. Further, it is desirable that the direction of the electric field is from the transporting belt 24 side to the charging member 61 side such that the negatively charged pigments move to the printing surface side of the paper S.

In the above description, the ink ejected from the head 31 contains pigments as the color material but the invention is not limited thereto. For example, the ink ejected from the head 31 may be ink containing aluminum flakes (a kind of metallic pigment) as the color material. The ink contains UV-curable resin and a solvent along with the aluminum flakes. The aluminum flake has a property of reflecting UV rays and the UV-curable resin is cured by being irradiated with UV rays.

When using such a kind of ink, the aluminum flakes move to the printing surface side of the paper S when charges are applied to the aluminum flakes (charging the aluminum flakes) by the charging member 61. Accordingly, the UV-curable resin can be easily irradiated with the UV rays. As a result, although the ink contains aluminum flakes, the entire ink can be adequately cured.

### Second Embodiment

Also according to a second embodiment, the charging member 61 also applies charges to pigments of ink on paper S before the irradiation of UV rays.

FIG. 8 is a schematic view illustrating a paper transporting unit 20 and a voltage applying unit 60 according to the second embodiment. Other units of the second embodiment have the same structure as in the first embodiment, thereby omitting the description.

In the second embodiment, the paper transporting unit 20 does not have a transporting belt 24 unlike the first embodiment (see FIG. 1), but transports paper S by using transporting rollers 22 and 23 in a transporting direction. That is, in the second embodiment, the transporting rollers 22 and 23 correspond to the transporting member.

The voltage applying unit 60 includes a charging member 61, a power source 62, and an electrode 63 which is an example of an electric field generating member. The charging member 61 and the power source 62 have the same structure as in the first embodiment. The discharge of electricity occurs due to the charging member 61 to which a high voltage is applied from the power source 62 and the pigments in the ink are applied with charges. The electrode 63 is a plate made of aluminum, and the charging member 61 and the electrode 63 constitute a pair of electrodes facing each other via the paper S provided between them. With such a structure, the electric field is generated between the charging member 61 to which the voltage is applied and the electrode 63. The direction of the generated electric field is from the charging member 61 to the electrode 63. The charged pigments in the ink on the paper S move to the printing surface side of the paper S under the action of the electric field like in the first embodiment.

On the other hand, in the second embodiment, a light source 42 is obliquely disposed. In more detail, the light source 42 is disposed such that an irradiating surface 42a of the light source 42 from which UV rays are emitted faces the electrode 63. With such a structure, it is possible to have the ink containing pigments under the action of electric field exposed to the UV rays. As a result, it is possible to efficiently cure the ink in the state of FIG. 5B.

Placement of the light source 42 is not limited to the position shown in FIG. 8. For example, the light source 42 may be placed over the charging member 61. In such a case, it is preferable that the charging member 61 be made of a transparent material so that the UV rays irradiated from the light source 42 can reach the ink. In such a case, since the generation of the electric field and the irradiation of the UV rays are substantially simultaneously performed, it is possible to save the space occupied by the device.

### Other Embodiments

Although the fluid ejecting device according to the invention is described with reference to the above specific embodiment, the embodiments are provided to help people better understand the invention and therefore they must not be construed in a limiting. Various modifications and alterations of the disclosed embodiments and other embodiments of the present invention will become apparent to persons skilled in the art upon reference to the description of the invention without departing from the spirit of the invention. It is therefore contemplated that the appended claims will cover any such modifications or equivalents as fall within the true scope of the invention.

In the above embodiments, the fluid ejecting device is actualized in the form of an ink jet printer but may not be limited thereto. That is, the fluid ejecting device can be realized in the form of a fluid ejecting device which can eject or discharge liquid (including a liquid material in which particles of a functional material are dispersed besides the liquid) other than ink or fluid (solid that can be ejected after flowing like fluid) other than liquid.

For example, the fluid ejecting device may be a liquid material ejecting device which ejects a liquid material in which an electrode material or a color material used to manufacture a fluid crystal display, an electroluminescence display, or a surface light-emitting display is dispersed or dissolved, a liquid ejecting device which ejects a bioorganic material used to manufacture a biochip, and a liquid ejecting device which ejects liquid serving as a sample used as a precision pipette. Further, the fluid ejecting device may be a liquid ejecting device which ejects lubricant oil to a precision machine such as a watch and a camera at a pinpoint, a liquid ejecting device which ejects transparent resin liquid such as UV-curable resin onto a substrate to form a fine hemispherical lens (optical lens) used in an optical communication element and so on, a liquid ejecting device which ejects an etching solution such as acid or alkali to etch a substrate, a fluid material ejecting device which ejects gel, or a powder-ejection-type recording device which ejects powder of solid such as toner. The invention can be applied to any kind of these devices.

In the above embodiment, the light source is a metal halide lamp but the invention is not limited thereto. For example, the light source may be a light-emitting diode (LED).

In addition, the ink ejection method is not limited to a method of using the piezo-electric element but the invention may be applied to also, for example a thermal printer.

What is claimed is:

1. A fluid ejecting device comprising:
a transporting member for transporting a medium in a transporting direction;
a fluid ejecting head for ejecting fluid containing a color material onto the medium;
an irradiating unit provided on the downstream side of the fluid ejecting head in the transporting direction to cure the fluid by irradiating the fluid on the medium with ultraviolet rays; and
a charge applying member for applying charges to the color material of the fluid on the medium before irradiation of the fluid with the ultraviolet rays.

2. The fluid ejecting device according to claim 1, further comprising:
an electric field generating member for generating electric field with respect to the fluid containing the color material to which the charges are applied before irradiating the fluid with ultraviolet rays by working together with the charge applying member which faces the electric field generating member via the medium provided between them;
wherein the charge applying member is positioned on the irradiating member side when viewed from the medium side;
wherein the electric field generating member is positioned on the opposite side of the irradiating member when viewed from the medium side; and
wherein the color material to which the charges are applied moves in a direction which directs from the charge applying member to the electric field generating member by operation of the electric field.

3. The fluid ejecting device according to clam 1,
wherein the charge applying member is provided at a position spaced apart from the fluid ejecting head on the downstream side in the transporting direction.

4. An image forming method comprising:
transporting a medium;
ejecting fluid containing a color material onto the medium which is being transported;
applying charges to the color material of the fluid on the medium; and
curing the fluid by irradiating the fluid containing the color material, to which the charges are applied, with ultraviolet rays.
